(19) United States
(12) Patent Application Publication
(10) Pub. No.: US 2013/0275916 A1
(43) Pub. Date: Oct. 17, 2013

(54) SYSTEM AND METHOD FOR ENTERING DATA ON PORTABLE ELECTRONIC DEVICE

(71) Applicant: Richard Schenker, Portland, OR (US)

(72) Inventor: Richard Schenker, Portland, OR (US)

(21) Appl. No.: 13/976,018

(22) PCT Filed: Sep. 30, 2011
(86) PCT No.: PCT/US11/54363

§ 371 Date: Jun. 25, 2013

(51) Int. Cl. G06F 3/0482

(52) U.S. Cl. CPC G06F 3/0482
USPC 715/840

(57) ABSTRACT

Various embodiments are directed to a portable electronic device that may utilize front input buttons capable of multiple settings on a front surface that may also include a display. The front input buttons may be ergonomically positioned to be easily accessible to the thumbs of a human operator. A rear surface of the portable electronic device may include one or more rear input buttons ergonomically positioned to be easily accessible to the fingers of a human operator when held. A graphical user interface (GUI) may be operative to display character or command input options for each of the rear input buttons. The character or command input options may be based on a particular setting of one of the front input buttons. A processor circuit may be operative to receive input from the front input buttons indicative of a particular setting and input from the rear input buttons. The input may be indicative of a character or command input option. The processor circuit may further be operative to display the character or command input option. The character or command input options for the rear buttons may be presented in substantially the same orientation as the rear buttons so as to make the display more intuitive to a human operator.

### BACKGROUND

Portable electronic devices utilize a variety of human operator input mechanisms including keyboards and touchscreens. Data input using these mechanisms may not always be easy or intuitive based on the small size of the devices. Accordingly, there may be a need for improved techniques to solve these and other problems.

### BRIEF DESCRIPTION OF THE DRAWINGS

FIG. 1 illustrates a front view of one embodiment of data entry components integrated into a portable electronic device.

FIG. 2 illustrates a rear view of one embodiment of data entry components integrated into a portable electronic device.

FIG. 3 illustrates a screen display of one embodiment of a portable electronic device.

FIG. 4 illustrates a screen display of one embodiment of a portable electronic device.

FIG. 5 illustrates a screen display of one embodiment of a portable electronic device.

FIG. 6 illustrates a screen display of one embodiment of a portable electronic device.

FIG. 7 illustrates a front view of another embodiment of data entry components integrated into a portable electronic device.

FIG. 8 illustrates one embodiment of a logic flow.

FIG. 9 illustrates one embodiment of a computing architecture.

### DETAILED DESCRIPTION

In various embodiments, data entry components may address common deficiencies associated with current data entry techniques associated with portable electronic devices. A portable electronic device may include, but is not limited to, a smartphone, a portable electronic gaming device, or a portable tablet computer.

The data entry components may utilize, in some embodiments, one or more front input buttons on a front surface that may also include an electronic display. The front input buttons may comprise multi-directional push buttons. The front input buttons may be ergonomically positioned to be easily accessible to a human operator's thumbs. Each front input button may be capable of multiple settings. A rear surface of the portable electronic device may include one or more rear input buttons ergonomically positioned to be easily accessible to a human operator's fingers when held. A graphical user interface (GUI) component may be operative to present character or command input options for each of the rear input buttons on an electronic display. The character or command input options may be based on a particular setting of one of the front input buttons.

A processor circuit may be communicatively coupled with the front input buttons, the rear input buttons, the electronic display, and the GUI component. The processor circuit may be operative to receive input from the front input buttons. The input may be indicative of a particular setting. The processor circuit may further be operative to receive input from the rear input buttons. The input may be indicative of a character or command input option. The GUI component on the processor circuit may be operative to present the character or command input option on the electronic display. The character or command input options for the rear buttons may be presented in substantially the same orientation as the rear buttons so as to make the presentation more intuitive to a human operator.

The term “character” as used throughout this disclosure may refer to an individual character such as, for instance, any character from the American Standard Code for Information Interchange (ASCII) character set. The term character, while singular, may also refer to multiple characters such as a word, an acronym, slang like abbreviations like those used in text messaging, etc . . . The term character may also refer to pictures or icons such as, for instance, emoticons.

The GUI component may be operative to present the character or command input options that are associated with the rear input buttons in an orientation that is substantially the same as the orientation of the rear input buttons.

The character or command input options for the rear input buttons may be different for each of the multiple settings of the front input buttons such that each time a front button setting is changed, a new set of character or command input options for the rear buttons may be presented.

In some embodiments, the electronic display may be a touchscreen display in which the front input buttons may be implemented by software and presented on the touchscreen display.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

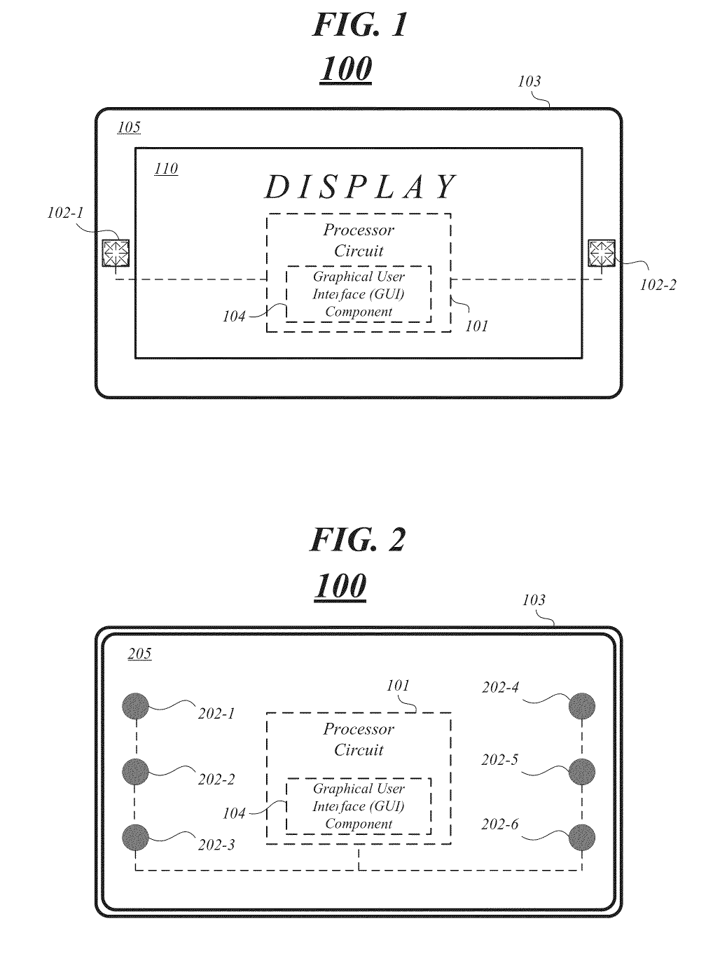

FIG. 1 illustrates a front view of one embodiment of data entry components integrated into a portable electronic device 100. A housing 103 for the portable electronic device 100 includes a front surface 105 and an electronic display 110. A processor circuit 101 may be operative to present on electronic display 110 text and images to a human operator of the portable electronic device 100 via a graphical user interface (GUI) component 104. A first front input button 102-1 communicatively coupled with the processor circuit 101 may be substantially positioned on the left hand side of the front surface 105 when the portable electronic device 100 is shown in landscape format. A second front input button 102-2 communicatively coupled with the processor circuit 101 may be substantially positioned on the right hand side of the front surface 105 when the portable electronic device 100 is shown in landscape format. The position of the front input buttons 102-1, 102-2 may be based on ergonomic factors. When the portable electronic device 100 is held by a human operator in the landscape format as shown, the front input buttons 102-1, 102-2 may be easily and comfortably accessible by a human operator's thumbs. The embodiments are not limited in this context.

The front input buttons 102-1, 102-2 may each be capable of multiple settings. For example, front button 102-1 may be partitioned into several regions each associated with a different setting. For example, the arrows shown indicate eight (8) different directions that can be associated with compass directions for reference purposes. These include north, south, east, west, northeast, northwest, southeast, and southwest. When a human operator actuates a front button 102-1 in one of the aforementioned compass directions, a setting associated with that compass direction may be applied by the processor circuit 101. The same may apply to front button 102-2. The front button settings may be used in conjunction with one or more rear input buttons in a manner to be described below. The embodiments are not limited in this context.

The front input buttons 102-1, 102-2 may include, but are not limited to, mechanical actuators, multiple directional buttons, and raised buttons. The front input buttons 102-1, 102-2 may operate on rocker type switch mechanisms to distinguish from among the multiple settings capable of selection by a human operator. A raised button may be actuated to enter a shift mode and actuated again to exit a shift mode. The shift mode may, for example, change the current setting from lower case to upper case, for instance.

FIG. 2 illustrates a rear view of one embodiment of data entry components integrated into a portable electronic device 100. The rear surface 205 of housing 103 of the portable electronic device 100 includes a set of rear input buttons 202-1 through 202-6 communicatively coupled with the processor circuit 101. Rear input buttons 202-1, 202-2, and 202-3 may be substantially vertically positioned on the left hand side of the rear surface 205 when the portable electronic device 100 is shown in landscape format. Rear input buttons 202-4, 202-5, and 202-6 may be substantially vertically positioned on the right hand side of the rear surface 205 when the portable electronic device 100 is shown in landscape format. The position of the rear input buttons 202-1 through 202-6 may be based on ergonomic factors. When the portable electronic device 100 is held by a human operator in the landscape format as shown, the rear input buttons 202-1 through 202-6 may be easily and comfortably accessible by a human operator's fingers. The embodiments are not limited in this context.

Each rear input button 202-1 through 202-6 may be associated with a character input option or a command input option for data input purposes. In this example, there are six (6) rear input buttons 202-1 through 202-6 so there may be six (6) character or command input options. The character or command input options may be presented on electronic display 110 by GUI component 104 in an orientation that is substantially similar to the orientation of the rear input buttons 202-1 through 202-6 on rear surface 205 creating a one-to-one correspondence. The character or command input options may change depending on the setting(s) of the front input buttons 102-1, 102-2.

While not specifically shown, one embodiment may include eight (8) rear input buttons rather than six (6). The eight (8) rear input buttons may be arranged in an orientation of two vertical lines of four (4) on either side of the rear surface 205 of housing 103. The embodiments are not limited in this context.

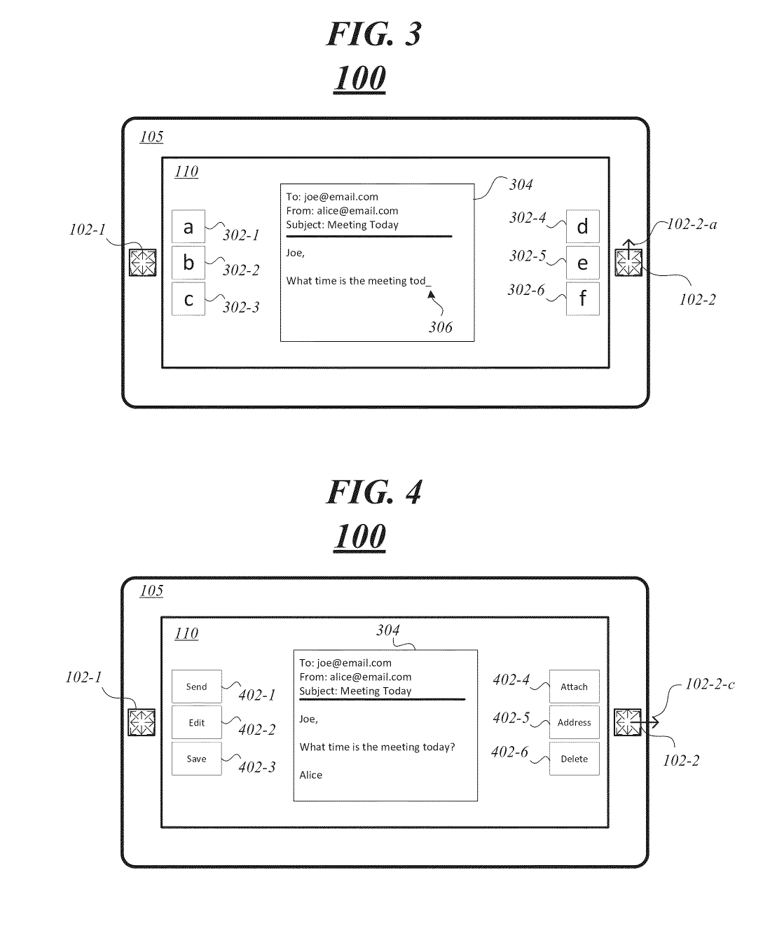

FIG. 3 illustrates a screen display 105 of one embodiment of a portable electronic device 100. In this example, electronic display 110 may be presenting the composition of an email message 304. A set of character input options 302-1 through 302-6 may be presented on either side of the email message 304. The set of character input options 302-1 through 302-6 may be oriented substantially the same as rear input buttons 202-1 through 202-6 by GUI component 104. Front input button 102-2 is shown with one of its directional arrows 102-2-a exaggerated for illustrative purposes only. The exaggeration is indicative that the human operator may have chosen a setting for front button 102-2 corresponding to directional arrow 102-2-a. In this example, the front button 102-2 may be associated with character input options “a” 302-1, “b” 302-2, “c” 302-3, “d” 302-4, “e” 302-5, and “f” 302-6. Specifically, the front button 102-2 setting 102-2-a may be associated with character input option “a” 302-1. The embodiments are not limited in this context.

In operation, a human operator may select one of the character input options 302-1 through 302-6 to enter into the email message 304. As the email message 304 is shown, the next letter 306 to be input is likely “a” because the word to be spelled is “today”. To enter the “a”, a human operator may depress rear input button 202-1 as it corresponds to character input option “a” 302-1. The human operator may then change the setting of front input button 102-1 or 102-2 to display a new set (not shown) of character input options 302-1 through 302-6 wherein one of the options in the new set is “y”. The human operator may have knowledge of the character input options 302-1 through 302-6 associated with each setting of the front buttons 102-1 and 102-2. The embodiments are not limited in this context.

In one embodiment, the character input options 301-1 through 301-6 may be programmed according to the most common input used by the human operator. For example, in the character input scenario above, the human operator may have a history of using specific character input options more frequently than others. The processor circuit 101 may organize the character input options 301-1 through 301-6 for each setting of a front input button 102-1, 102-2 according to the most used. If there are six (6) rear input buttons 202-1 through 202-6 then the six (6) most frequently used inputs of the human operator may be grouped together for a particular front input button 102-1, 102-2 setting.

It should be noted that not all front button 102-1, 102-2 settings need be associated with individual characters. Some of the front button 102-1, 102-2 settings may be associated with commands or functions. For instance, one front button 102-1, 102-2 setting may act as a shift key such that character input options 302-1 through 302-6 are presented as capital letters. In other embodiments, the front button 102-1, 102-2 settings may be associated with executable commands as described below. The embodiments are not limited in this context.

FIG. 4 illustrates a screen display 110 of one embodiment of a portable electronic device 100. FIG. 4 is a natural progression of FIG. 3. At this point, a human operator may have finished composing the email message 304 and may be ready to perform some other function with respect to email message 304. The human operator may have selected the arrow 102-2-c to change the setting for front button 102-2 such that a set of command input options 402-1 through 402-6 are presented by GUI component 104 on electronic display 110. In this example, the six (6) command input options may be “Send” 402-1, “Edit” 402-2, “Save” 402-3, “Attach” 402-4, “Address” 402-5, and “Delete” 402-6. Each of the command input options 402-1 through 402-6 may be associated with a command that may be performed when the human operator actuates a corresponding rear button 202-1 through 202-6. For instance, if the human operator wishes to send the email message 304, rear button 202-1 may be actuated since it corresponds with the “Send” command input option 402-1. Similarly, if the human operator wishes to add another addressee to the email message 304, rear button 202-5 may be actuated since it corresponds with the “Address” command input option 402-1. The embodiments are not limited in this context.

The idea of using command input options 402-1 through 402-6 has been presented through an example of composing an email message 304. It should be understood that command input option input 402-1 through 402-6 may extend to other applications and programs that may be run on the portable electronic device 100. For instance, a word processing application may allow text entry and also may allow for commands such as “bold”, “italic”, or “underline” to be applied to the text. Other commands such as, for instance, “save”, “exit”, and “copy” may be implemented for that particular application as well. Another example may be controlling the navigation of a web browser. Functional commands common to web browsing such as “back”, “forward”, “favorites”, “history”, etc. may be implemented as command input options 402-1 through 402-6 associated with rear buttons 202-1 through 202-6 for a particular front button 102-1, 102-2 setting. The embodiments are not limited in this context.

In one embodiment, the command input options 401-1 through 401-6 may be programmed according to the most common input used by the human operator. For example, in the command input scenario above, the human operator may have a history of using specific character input options more frequently than others. The processor circuit 101 may organize the command input options 401-1 through 401-6 for each setting of a front input button 102-1, 102-2 according to the most used. If there are six (6) rear input buttons 202-1 through 202-6 then the six (6) most frequently used inputs of the human operator may be grouped together for a particular front input button 102-1, 102-2 setting.

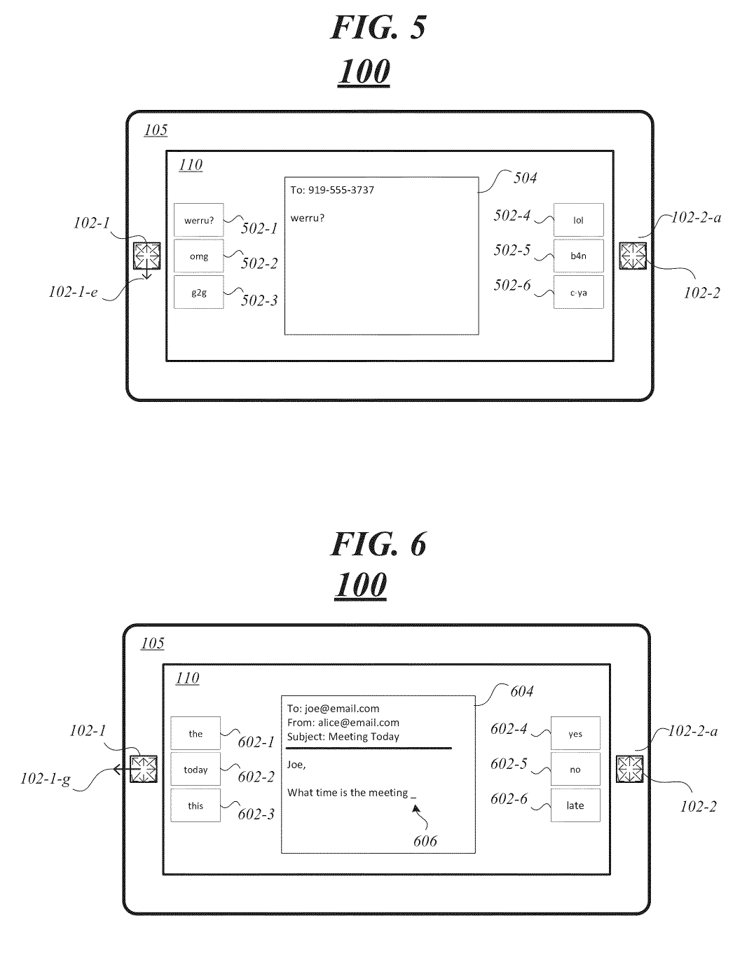

FIG. 5 illustrates a screen display 105 of one embodiment of a portable electronic device 100. In this example, a text messaging application is executing. A partial text message 504 is shown. A set of character input options 502-1 through 502-6 may be shown on either side of the text message 504 by GUI component 104 on electronic display 110. The set of character input options 502-1 through 502-6 may be oriented by GUI component 104 substantially the same as rear input buttons 202-1 through 202-6. Front input button 102-1 is shown with one of its directional arrows 102-1-e exaggerated for illustrative purposes only. The exaggeration is indicative that the human operator may have chosen a setting for front button 102-1 corresponding to directional arrow 102-1-e. In this example, the front button 102-1 may be associated with character input options “werru?” 502-1, “omg” 502-2, “g2g” 502-3, “lol” 502-4, “b4n” 502-5, and “c-ya” 502-6. These character input options 502-1 through 502-6 may be representative of text message slang. As stated earlier, a character need not be limited to a single character. Specifically, the front button 102-1 setting 102-1-e is associated with the character input option “werru?”. The embodiments are not limited in this context.

In one embodiment, the character input options 501-1 through 501-6 may be programmed according to the most common input used by the human operator. For example, in the text message scenario above, the human operator may have a history of using specific text message input options more frequently than others. The processor circuit 101 may organize the character input options 501-1 through 501-6 for each setting of a front input button 102-1, 102-2 according to the most used. If there are six (6) rear input buttons 202-1 through 202-6 then the six (6) most frequently used inputs of the human operator may be grouped together for a particular front input button 102-1, 102-2 setting.

As described for other embodiments, the human operator may select one of the character input options 502-1 through 502-6 as input for the text message 504 by actuating a corresponding rear button 202-1 through 202-6. In this example, the human operator has selected character input option 502-1 “werru?” by actuating rear button 202-1 as evidenced by the character string “werru?” appearing in the text message 504.

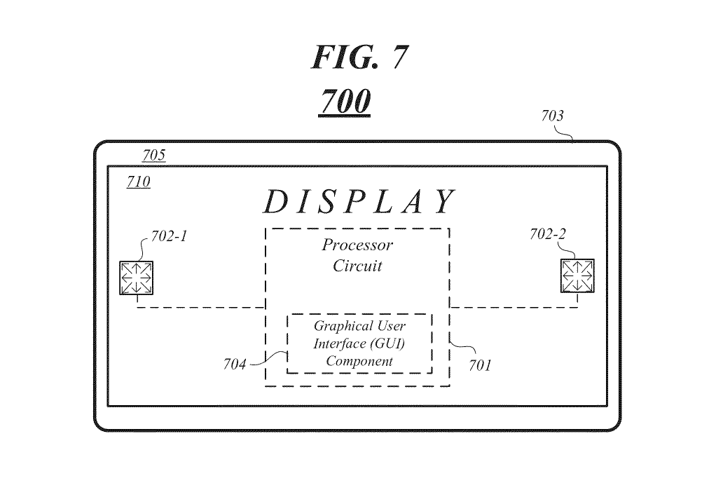

FIG. 6 illustrates a screen display 105 of one embodiment of a portable electronic device 100. In this example, an email application is executing. A partial email message 604 is shown. A set of character input options 602-1 through 602-6 may be shown on either side of the email message 604 on the electronic display 110 via the GUI component 104. The set of character input options 602-1 through 602-6 may be oriented substantially the same as rear input buttons 202-1 through 202-6. Front input button 102-1 is shown with one of its directional arrows 102-1-g exaggerated for illustrative purposes only. The exaggeration is indicative that the human operator may have chosen a setting for front button 102-1 corresponding to directional arrow 102-1-g. In this example, the front button 102-1 setting 102-1-g is associated with character input options 602-1 through 602-6 representative of the words “the” 602-1, “today” 602-2, “this” 602-3, “yes” 602-4, “no” 602-5, and “late” 602-6. The embodiments are not limited in this context.

As described for other embodiments, the human operator may select one of the character input options 602-1 through 602-6 as input for the email message 604 by actuating a corresponding rear button 202-1 through 202-6. In this example, the human operator is likely to select as the next character input option input the word “today” which is associated with character input option 602-2. This may be done by actuating rear button 202-2 as it corresponds to character input option 602-2.

In one embodiment, the character input options 601-1 through 601-6 may be programmed according to the most common input used by the human operator. For example, in the word scenario above, the human operator may have a history of using specific word input options more frequently than others. The processor circuit 101 may organize the character input options 601-1 through 601-6 for each setting of a front input button 102-1, 102-2 according to the most used. If there are six (6) rear input buttons 202-1 through 202-6 then the six (6) most frequently used inputs of the human operator may be grouped together for a particular front input button 102-1, 102-2 setting.

FIG. 7 illustrates a front view of another embodiment of data entry components integrated into a portable electronic device. A housing 703 for the portable electronic device 700 includes a front surface 705 and a touchscreen display 710. The touchscreen display 710 may be operative to present text and images to a human operator of the portable electronic device 700 via a GUI component 704. A first front input button 702-1 communicatively coupled with the processor circuit 701 may be substantially positioned on the left hand side of the touchscreen display 710 when the portable electronic device 700 is shown in landscape format. A second front input button 702-2 communicatively coupled with the processor circuit 701 may be substantially positioned on the right hand side of the touchscreen display 710 when the portable electronic device 700 is shown in landscape format. The position of the front input buttons 702-1, 702-2 may be based on ergonomic factors. When the portable electronic device 700 is held by a human operator in the landscape format as shown, the front input buttons 702-1, 702-2 may be easily and comfortably accessible by a human operator's thumbs. The embodiments are not limited in this context.

The front input buttons 702-1, 702-2 may each be capable of multiple settings. For example, front button 702-1 may be partitioned into several regions each associated with a different setting. For example, the arrows shown indicate eight (8) different directions that can be associated with compass directions for reference purposes. These include north, south, east, west, northeast, northwest, southeast, and southwest. When a human operator presses on front button 702-1 in one of the aforementioned compass directions, a setting associated with that compass direction may be applied by the processor circuit 701. The same may apply to front button 702-2. The front button settings may be used in conjunction with the one or more rear input buttons 202-1 through 202-6 to present character or command input options on the touchscreen display 710 via GUI component 704 as described above. The embodiments are not limited in this context.

Included herein are one or more flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

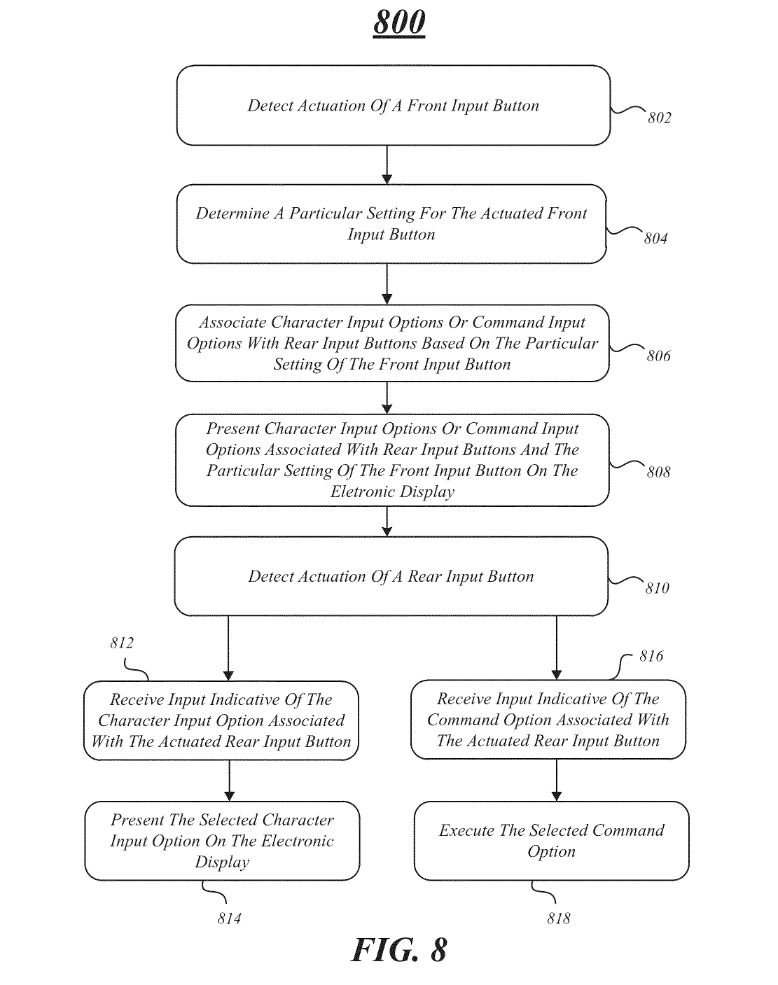

FIG. 8 illustrates one embodiment of a logic flow 800 in which the portable electronic device 100 implements a human operator interface for data entry. The logic flow 800 may be representative of some or all of the operations executed by one or more embodiments described herein.

A portable electronic device 100 may implement a method in which a setting of one or more ergonomically positioned front input buttons on a front surface is detected. The front input buttons may comprise multi-directional push buttons. Character input options 302-1 through 302-6 or command input options 402-1 through 402-6 for each of one or more ergonomically positioned rear input buttons 202-1 through 202-6 may be presented by GUI component 104 on electronic display 110 based on a particular setting of one of the front input buttons 102-1, 102-2.

A processor circuit 101 may be communicatively coupled with the front input buttons 102-1, 102-2, the rear input buttons 202-1 through 202-6, the electronic display 110, and the GUI component 104. The processor circuit 101 may be operative to receive input from the front input buttons 102-1, 102-2. The input may be indicative of a particular setting for the front buttons 102-1, 102-2. The processor circuit 101 may further be operative to receive input from the rear input buttons 202-1 through 202-6. The input may be indicative of a character input option 302-1 through 302-6 or a command input option 402-1 through 402-6. The processor circuit 101 may further be operative to present the character input option 302-1 through 302-6 or a command input option 402-1 through 402-6 via GUI component 104 on electronic display 110. The character input options 302-1 through 302-6 or a command input options 402-1 through 402-6 for the rear buttons 202-1 through 202-6 may be presented on electronic display 110 in substantially the same orientation as the rear buttons 202-1 through 202-6 so as to make the output of GUI component 104 more intuitive to a human operator.

In the illustrated embodiment shown in FIG. 8, a processor circuit 101 may detect actuation of a front input button 102-1, 102-2 at block 802. For example, a human operator may be holding the portable electronic device in an ergonomically comfortable position in which the human operator's thumbs may easily engage the front input buttons 102-1, 102-2. The human operator may actuate one of the front input buttons 102-1, 102-2 with a thumb in a particular direction or manner indicative of a setting for that front input button 102-1, 102-2. The processor circuit 101 then detects actuation of the front input button 102-1, 102-2 in the particular direction. The embodiments are not limited to this example.

The logic flow 800 may determine the particular setting for the actuated front input button 102-1, 102-2 at block 804. For example, the human operator may have manipulated front input button 102-1 in the northwest direction. The processor circuit 101 detects this action as described above and determines a set of character input options 302-1 through 302-6 or command input options 402-1 through 402-6 that may be associated with this particular setting for front input button 102-1. The embodiments are not limited to this example.

The logic flow 800 may associate character input options 302-1 through 302-6 or command input options 402-1 through 402-6 with rear input buttons 202-1 through 202-6 for this particular setting of front input button 102-1 at block 806. For example, the processor circuit 101 may have detected the particular setting of the front input button 102-1 as described above. The processor circuit now associates the particular setting of the front input button 102-1 with a set of character input options 302-1 through 302-6 or command input options 402-1 through 402-6. As an example, FIG. 3 illustrates the letters “a”, “b”, “c”, “d”, “e”, and “f” for character input options 302-1 through 302-6 respectively. As another example, FIG. 4 illustrates the commands “Send”, “Edit”, “Save”, “Attach”, “Address”, and “Delete” for command input options 402-1 through 402-6 respectively. The embodiments are not limited to these examples.

The logic flow 800 may present character input options 302-1 through 302-6 or command input options 402-1 through 402-6 associated with rear input buttons 202-1 through 202-6 and the particular setting of front input button 102-1 at block 808. For example, the GUI component 104 causes the electronic display 110 to present the character input options 302-1 through 302-6 or command input options 402-1 through 402-6. The character input options 302-1 through 302-6 or command input options 402-1 through 402-6 may be presented in an orientation that matches that of the rear input buttons 202-1 through 202-6 to make the presentation more intuitive to a human operator. The embodiments are not limited to this example.

The logic flow 800 may detect actuation of a rear input button 202-1 through 202-6 at block 810. For example, a human operator may be holding the portable electronic device in an ergonomically comfortable position in which the human operator's fingers may easily engage the rear input buttons 202-1 through 202-6. The human operator may actuate one of the rear input buttons 202-1 through 202-6 with a finger. The actuated rear input button 202-1 through 202-6 corresponds to a presented character input option 302-1 through 302-6 or command input option 402-1 through 402-6. The processor circuit 101 detects actuation of the rear input button 202-1 through 202-6. The embodiments are not limited to this example.

The logic flow 800 may receive input indicative of the character input option 302-1 through 302-6 associated with the actuated rear button 202-1 through 202-6 at block 812. For example, the processor circuit 101 having detected actuation of a rear input button 202-1 through 202-6 associates the actuated rear input button 202-1 through 202-6 with a corresponding one of character input options 302-1 through 302-6. The embodiments are not limited to this example.

The logic flow 800 may present the selected character input option 302-1 through 302-6 associated with the actuated rear button 202-1 through 202-6 at block 814. For example, the processor circuit 101 having determined a character input option 302-1 through 302-6 associated with the actuated rear input button 202-1 through 202-6 now causes the selected character input option 302-1 through 302-6 to be presented on electronic display 110. The embodiments are not limited to this example.

The logic flow 800 may receive input indicative of the command input option 402-1 through 402-6 associated with the actuated rear button 202-1 through 202-6 at block 816. For example, the processor circuit 101 having detected actuation of a rear input button 202-1 through 202-6 associates the actuated rear input button 202-1 through 202-6 with a corresponding one of command input options 402-1 through 402-6. The embodiments are not limited to this example.

The logic flow 800 may display the selected command input option 402-1 through 402-6 associated with the actuated rear button 202-1 through 202-6 at block 818. For example, the processor circuit 101 having determined a command input option 402-1 through 402-6 associated with the actuated rear input button 202-1 through 202-6 now causes the selected command input option 402-1 through 402-6 to be presented on electronic display 110. The embodiments are not limited to this example.

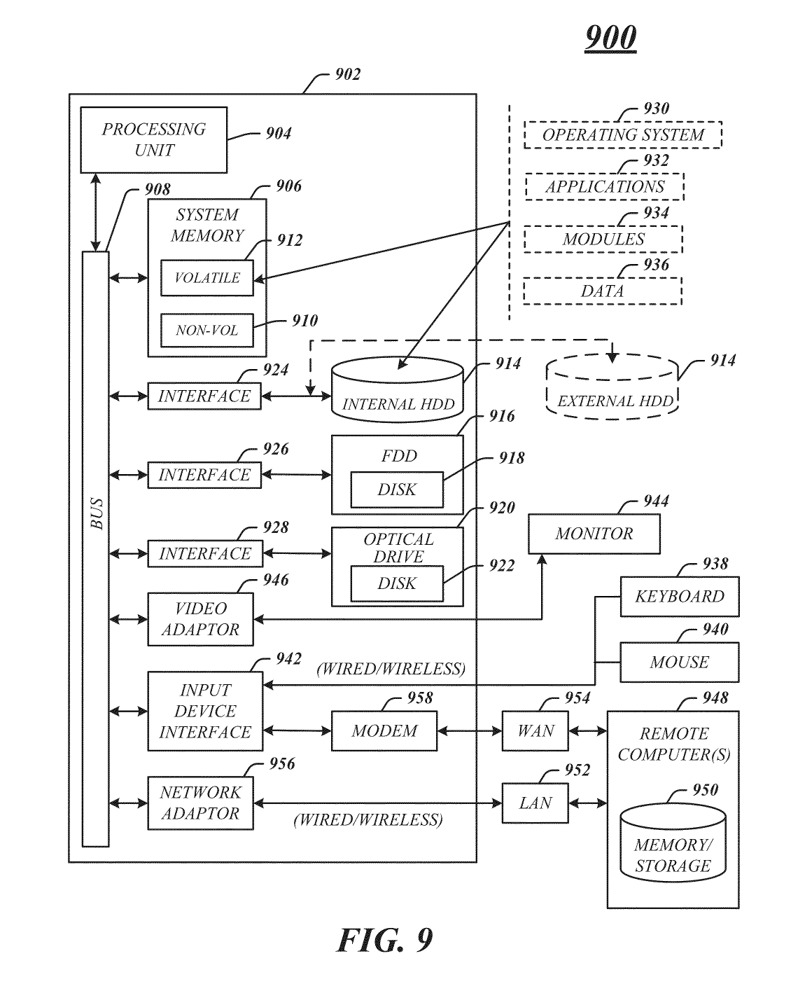

FIG. 9 illustrates an embodiment of an exemplary computing architecture 900 suitable for implementing various embodiments as previously described. As used in this application, the terms “system” and “device” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 900 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 900 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors. Dual microprocessors and other multi processor architectures may also be employed as the processing unit 904. The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures.

The computing architecture 900 may comprise or implement various articles of manufacture. An article of manufacture may comprise a computer-readable storage medium to store various forms of programming logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of programming logic may include executable computer program instructions implemented using any suitable type of code, such as source code, compiled code, interpreted code, executable code, static code, dynamic code, object-oriented code, visual code, and the like.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 6, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936.

A human operator can enter commands and information into the computer 902 through one or more wire/wireless input devices, for example, a keyboard 938 and a pointing device, such as a mouse 940. Other input devices may include a microphone, an infra-red (IR) remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a processor circuit;
an electronic display coupled to the processor circuit;
a housing for the processing circuit and the electronic display, the housing having a rear surface having one or more rear input buttons; and
a graphical user interface (GUI) component operative on the processor circuit to generate a GUI view arranged to present one or more character or command input options for the one or more rear input buttons, the one or more character or command input options based on a particular one of multiple settings of one or more front input buttons.

2. The apparatus of claim 1, the GUI component operative to present the one or more character or command input options in an orientation that is substantially the same as the orientation of the one or more rear input buttons.

3. The apparatus of claim 2 wherein the processor circuit is operative to recognize the character or command input option presented by the GUI component corresponding to the rear input button that is in substantially the same orientation.

4. The apparatus of claim 1 wherein the one or more front input buttons are positioned so as to be ergonomically accessible to one or more thumbs of a human operator.

5. The apparatus of claim 1 wherein the one or more rear input buttons are positioned so as to be ergonomically accessible to one or more fingers of a human operator.

6. The apparatus of claim 1 wherein the one or more character or command input options are different for the multiple settings of the one or more front input buttons.

7. The apparatus of claim 1 wherein the one or more character input options includes a subset of the American Standard Code for Information Interchange (ASCII) character set.

8. The apparatus of claim 7 wherein a setting for a front input button is a shift key operative to provide one or more upper case character input options for the one or more rear input buttons.

9. The apparatus of claim 1 wherein the one or more character input options includes text message abbreviations.

10. The apparatus of claim 1 wherein the electronic display is a touchscreen display.

11. The apparatus of claim 10 wherein the one or more front input buttons are implemented as software on the touchscreen display.

12. A method comprising:
detecting actuation of a front input button, the front input button capable of multiple settings;
determining a particular setting for the actuated front input button;
associating one or more character or command input options with one or more rear input buttons based on the particular setting of the front input button;
presenting the one or more character or command input options associated with one or more rear input buttons;
detecting actuation of a rear input button;
receiving input indicative of the character or command input option associated with the actuated rear input button; and
presenting the character or command input option.

13. The method of claim 12, comprising presenting the one or more character or command input options in an orientation that is substantially the same as an orientation of the one or more rear input buttons.

14. The method of claim 12 wherein the one or more character or command input options are different for the multiple settings of the front input button.

15. The method of claim 12 wherein the one or more character input options includes a subset of the American Standard Code for Information Interchange (ASCII) character set.

16. The method of claim 15 wherein one of the multiple settings for the front input button is a shift key operative to provide one or more upper case character input options for each of the one or more rear input buttons.

17. The method of claim 12 wherein the one or more character input options includes text message abbreviations.

18. An article of manufacture comprising a computer-readable storage medium containing instructions that when executed enable a system to:
determine a particular setting for an actuated front input button;
associate one or more character or command input options with one or more rear input buttons based on the particular setting of the front input button;
present the one or more character or command input options associated with the one or more rear input buttons;
receive input indicative of the character or command input option associated with an actuated rear input button; and
present the character or command input option.

19. The article of claim 18, further comprising instructions that when executed enable the system to present the one or more character or command input options in an orientation that is substantially the same as an orientation of the one or more rear input buttons.

20. The article of claim 18 wherein the one or more character or command input options are different for the multiple settings of the front input button.

21. The article of claim 18 wherein the one or more character input options includes a subset of the American Standard Code for Information Interchange (ASCII) character set.

22. The article of claim 18 wherein one of the multiple settings for the front input button is a shift key operative to provide one or more upper case character input options for each of the one or more rear input buttons.

23. The article of claim 18 wherein the one or more character input options for the one or more rear input buttons includes text message abbreviations.

24. The article of claim 18 wherein the display is a touchscreen display and the front input button is implemented by software and presented on the touchscreen display.
